(19) United States
(12) Patent Application Publication
(10) Pub. No.: US 2024/0167553 A1
(43) Pub. Date: May 23, 2024

(54) ELECTRIC DRIVE MODULE

(71) Applicant: BorgWarner Sweden AB, Landskrona (SE)

(72) Inventors: Isak ANDERSSON, Kvidinge (SE); Ted BRINK, Flyinge (SE); Tobias PERSSON, KÄVLINGE (SE)

(21) Appl. No.: 18/282,950

(22) PCT Filed: Mar. 24, 2022
(86) PCT No.: PCT/EP2022/057784

§ 371 Date: Sep. 19, 2023

(30) Foreign Application Priority Data
Mar. 24, 2021 (SE) 2150342-0

(51) Int. Cl. F16H 48/36; B60K 1/02; B60K 17/356; F16H 37/08

(52) U.S. Cl. CPC F16H 48/36; B60K 1/02; B60K 17/356; F16H 37/0806; F16H 2048/364

(57) ABSTRACT

An electric drive module including a differential providing output torque to two drive shafts, an electric drive motor, an electric torque vectoring motor, and a pinion, in which the pinion is drivingly connected to the differential via a reduction gear. The electric drive motor may be arranged coaxially with the two drive shafts. The electric torque vectoring motor may be arranged off-axis and/or in parallel with, but at a distance from, the two drive shafts.

### TECHNICAL FIELD

The present invention relates to an electric drive module for a vehicle. In particular, the present invention relates to an improved module for a vehicle enabling electric drive and electric torque vectoring.

### BACKGROUND

There is an increasing demand for electric drive modules. In view of the existing products on the market there is a need for improvements, especially for providing a compact drive module as well as in terms of functionality, performance, and cost effectiveness.

### SUMMARY

The present invention seeks to overcome the drawbacks of existing systems by providing an improved electric drive module as defined by the independent claims. Preferred embodiments are defined by the dependent claims.

According to a first aspect, an electric drive module is provided. The electric drive module comprises a differential providing output torque to two drive shafts, an electric drive motor, an electric torque vectoring motor, and a pinion, wherein the pinion is drivingly connected to the differential via a reduction gear.

According to a second aspect, an electric drive module is provided. The electric drive module comprises a differential providing output torque to two drive shafts, an electric drive motor, an electric torque vectoring motor, and a pinion, wherein the electric drive motor is arranged coaxially with the two drive shafts.

According to a third aspect, an electric drive module is provided. The electric drive module comprises a differential providing output torque to two drive shafts, an electric drive motor, an electric torque vectoring motor, and a pinion, wherein the electric torque vectoring motor is arranged off-axis.

According to a fourth aspect, an electric drive module is provided. The electric drive module comprises a differential providing output torque to two drive shafts, an electric drive motor, an electric torque vectoring motor, and a pinion, wherein the electric drive motor is drivingly connected to the differential via a planetary gear set.

According to a fifth aspect, an electric drive module is provided. The electric drive module comprises a differential providing output torque to two drive shafts, an electric drive motor, an electric torque vectoring motor, and a pinion, wherein the electric drive module further comprises a disconnect arranged between the electric drive motor and the differential.

According to a sixth aspect, an electric drive module is provided. The electric drive module comprises a differential providing output torque to two drive shafts, an electric drive motor, an electric torque vectoring motor, and a pinion, wherein the electric torque vectoring motor is connected to one of the drive shafts as well as to the differential via a double planetary gear set.

According to a seventh aspect, an electric drive module is provided. The electric drive module comprises features of the first, second, third, fourth, fifth, or sixth aspect listed above in any combination. Accordingly, according to the seventh aspect an electric drive module is provided. The electric drive module comprises a differential providing output torque to two drive shafts, an electric drive motor, an electric torque vectoring motor, and a pinion. The pinion is drivingly connected to the differential via a reduction gear, and/or the electric drive motor is arranged coaxially with the two drive shafts, and/or the electric torque vectoring motor is arranged off-axis, and/or the electric drive motor is drivingly connected to the differential via a planetary gear set, and/or the electric drive module further comprises a disconnect arranged between the electric drive motor and the differential, and/or the electric torque vectoring motor is connected to one of the drive shafts as well as to the differential via a double planetary gear set.

### BRIEF DESCRIPTION OF THE DRAWINGS

In the following, reference will be given by the appended drawings in which:

FIG. 1a is a schematic view of a vehicle according to an embodiment;

FIG. 1b is a cross-sectional view of an electric drive module according to an embodiment, and

FIG. 2 is a schematic diagram of the electric drive module shown in FIG. 1.

### DETAILED DESCRIPTION

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended claims. Furthermore, the terminology used in the detailed description of the particular embodiments illustrated in the accompanying drawings is not intended to be limiting of the invention.

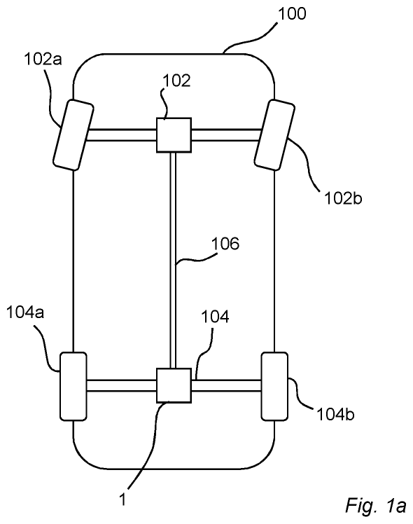

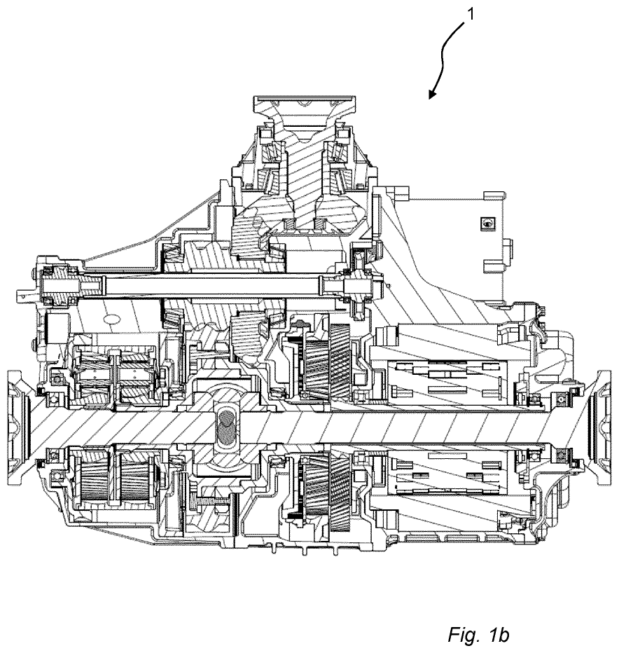

Starting in FIG. 1a, a vehicle 100 is schematically shown. The vehicle 100 is provided with a front axle 102 which is configured to provide drive torque to left and right front wheels 102a-b, and a rear axle 104 which is configured to provide drive torque to left and right rear wheels 104a-b. Although not described further herein, the front axle 102 may be driven by a combustion engine (not shown) or by an electrical machine (not shown).

As will be explained in the following, by activation of the rear axle 104 four-wheel drive, AWD, or rear-wheel drive, RWD, of the vehicle 100 is provided. The rear axle 104 is also capable of providing torque vectoring as will be further explained in the following.

In the shown example, at least one of the front axle 102 or the rear axle 104 is provided with an electric drive module 1. Further, the front axle 102 is connected, or at least connectable, with the rear axle 104 by means of a prop shaft 106.

In FIG. 1b a cross-sectional view of an electric drive module 1 is shown. The electric drive module 1 is preferably arranged on a rear axle of an associated vehicle, as exemplified in FIG. 1a, however in some applications it may be desirable to arrange the electric drive module 1 on the front axle of the vehicle.

The electric drive module 1 allows for purely mechanical drive, purely electric drive or hybrid drive. The electric drive module 1 also allows for torque vectoring as an addition to any of the above-mentioned drive modes. As can be seen in FIG. 1b, all these drive modes are available by an extremely compact construction.

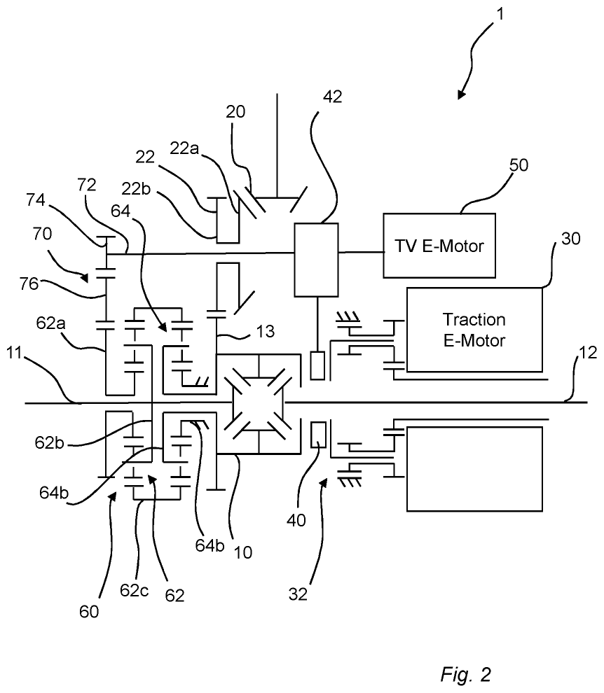

Now turning to FIG. 2, details of the electric drive module 1 are further explained. The electric drive module 1 comprises a conventional differential 10 distributing drive torque to left and right wheel shafts 11, 12. With reference to FIG. 1a, the left wheel shaft 11 is driving one of the wheels 104a-b while the right wheel shaft 12 is driving the other one of the wheels 104a-b.

Drive torque is provided either from a pinion 20 (mechanical drive), from an electric drive motor 30 (electric drive), or both (hybrid drive). The pinion 20 may e.g. be connected to an internal combustion engine via the prop shaft 106 (see FIG. 1a).

The pinion 20 is not connecting directly to the differential input, but there is a reduction gear 22 arranged in between the pinion 20 and the differential 10. The reduction gear 22 allows for flexibility when positioning the pinion 20 relative the differential 10, as well as an increased diameter of the differential input, i.e. the differential crown wheel 13. In the shown example the reduction gear has a bevelled input gear 22a, meshing with the pinion 20 to receive input torque, and a circular output gear 22b that meshes with the differential crown wheel 13. The input gear 22a and the output gear 22b can be arranged concentrically.

The electric drive motor 30 is arranged on one side of the differential 10, coaxially with the right wheel shaft 12, and a planetary gear set 32, preferably a compound two-step planetary gear set, is arranged between the electric motor 30 and the differential input. The electric drive motor 30 may be driving a sun gear 32a of the planetary gear set 32. The planet carrier 32b forms the output while the ring gear 32c is fixed.

A disconnect 40 is arranged between the differential input and the planet carrier for selectively disconnecting the electric drive motor 30 from the drive train. For this a disconnect actuator 42 is provided, which is configured to control the position of the disconnect 40, and hence if the electric drive motor 30 is in driving connection with the differential 10 or not. The disconnect actuator 42 may be a hydraulic actuator, an electromechanical actuator, etc. When the disconnect 40 is in a connected mode, the electric drive motor 30 will be rotatably driving the differential input via the planetary gear set 32.

Torque vectoring is made available by means of an electric torque vectoring motor 50 which is arranged off-axis, i.e. the torque vectoring motor 50 is displaced relative a central axis of the electric drive module 1. In particular, the central axis may be seen as a virtual axis extending along, and coinciding with, the left and right wheel shafts 11, 12. As can be seen in FIG. 2 the electric drive motor 30 as well as the torque vectoring motor 50 may be arranged in parallel with the central axis.

The electric torque vectoring motor 50 is connected to a double planetary gear set 60 arranged on the opposite side of the differential 10 compared to the electric drive motor 30, via a reduction gear 70. The reduction gear 70 may comprise a shaft 72 extending across at least parts of the electric drive module 1, in parallel with the central axis. Preferably, the shaft 72 extends through the reduction gear 22 connecting the pinion 20 with the differential 10. For this, the reduction gear 22, i.e. the input gear 22a and the output gear 22b, is provided with a central passage for allowing the shaft 72 to rotate upon activation of the torque vectoring motor 50.

The end of the shaft 72 is provided with a gear 74 meshing with an intermediate gear 76 which in turn is meshing with a sun gear 62a of the double planetary gear set 60; hence the reduction gear 70 is formed by the shaft 72, the gear 74, and the intermediate gear 76.

The reduction gear 70 is driving the sun gear 62a of the first planetary gear set 62, and the planet carrier 62b of the first planetary gear set 62 is connected to the left drive shaft 11. A common ring wheel 62c connects the first planetary gear set 62 with the second planetary gear set 64. The second planetary gear set 62 has a fixed sun gear 64a, while the planet carrier 64b of the second planetary gear set 64 connects to the differential input 13.

When the torque vectoring motor 50 is activated, shuffling of torque between the drive shafts 11, 12 will be accomplished due to the connection to the drive axle 11 and to the differential input 13.

It should be mentioned that the inventive concept is by no means limited to the embodiments described herein, and several modifications are feasible without departing from the scope of the invention as defined in the appended claims.

1. An electric drive module, comprising a differential providing output torque to two drive shafts, an electric drive motor, an electric torque vectoring motor, and a pinion, in which the pinion is drivingly connected to the differential, via a reduction gear.

2. The electric drive module according to claim 1, wherein the electric drive motor is arranged coaxially with the two drive shafts.

3. The electric drive module according to claim 1, wherein the electric torque vectoring motor is arranged off-axis.

4. The electric drive module according to claim 3, wherein the electric torque vectoring motor is arranged in parallel with, but at a distance from, the two drive shafts.

5. The electric drive module according to claim 1, wherein the electric drive motor is drivingly connected to the differential via a planetary gear set.

6. The electric drive module according to claim 1, wherein the electric drive module further comprises a disconnect arranged between the electric drive motor and the differential.

7. The electric drive module according to claim 1, wherein the electric torque vectoring motor is connected to one of the drive shafts as well as to the differential via a double planetary gear set.

8. A vehicle, comprising an electric drive module according to claim 1.

9. The electric drive module according to claim 2, wherein the electric torque vectoring motor is arranged off-axis.

10. The electric drive module according to claim 9, wherein the electric torque vectoring motor is arranged in parallel with, but at a distance from, the two drive shafts.
